(19) United States
(12) Patent Application Publication
(10) Pub. No.: US 2017/0358019 A1
(43) Pub. Date: Dec. 14, 2017

(54) PERSONAL SKIN CARE PRODUCT INGREDIENT ANALYSIS DEVICE BASED ON INHERENT SKIN INFORMATION

(71) Applicant: UNION APPLIED GENE INC., TAIPEI CITY (TW)

(72) Inventor: Hung-Wei SHU, TAIPEI CITY (TW)

(21) Appl. No.: 15/180,066

(22) Filed: Jun. 12, 2016

(51) Int. Cl. G06Q 30/06; G06F 19/18

(52) U.S. Cl. CPC G06Q 30/0621; G06F 19/18

(57) ABSTRACT

A personal skin care product ingredient analysis device based on inherent skin information includes: a user interface; a skin type database; a skin care product ingredient database; an analysis server; an analysis result database; a production control server; and a management control interface. The personal skin care product ingredient analysis device is capable of inputting personal data and skin related gene detection data, and automatically connected to a plurality of databases to perform interactive analysis, and finally personal skin care ingredient formula can be produced automatically, so that manufacturers can make suitable personal skin care products according to various inherent skin natures, so as to provide reliable and effective exclusive personal skin care product which is capable of improving skin health and delaying skin aging.

### BACKGROUND OF THE INVENTION

### Field of the Invention

The present invention relates to an analysis device, and more particularly to a personal skin care product ingredient analysis device based on inherent skin information.

### Related Prior Art

Cosmetic industry is a combination of science and technology and aesthetics, and has a good image of high added value and low pollution. As the knowledge of body care, body shaping and skin care gradually comes to be known, body or local skin care products have gradually become necessities in daily life. However, individual's skin varies, each person's skin is different, and the required nutrition ingredients are also different. Therefore, changes must be made based on personal physical conditions to promote skin health and protect natural skin in a more efficient way.

Taiwan Patent No. 1301890 discloses a system and method for skin diagnosis and selection of cosmetic care products, which includes a skin condition database, a cosmetic product knowledge database, a logical operation processing module, a formula or product suggestion module, and a diagnosis suggestion module. After the user inputs a skin condition, the system can obtain an optimum formula and product information through comparison operation.

Another Taiwan Patent M503619 discloses a cosmetic care product suggestion device, which is capable of inputting a skin image and comparing it with the built-in skin condition data, then producing a skin diagnosis result, then finding out an optimum cosmetic care formula and use schedule from the cosmetic product knowledge database, and providing network purchase to allow the user to buy the desired cosmetic care product suitable for the user's skin.

However, it is difficult for a normal person to describe the skin in a specific and objective manner, so the obtained state of the skin does not represent the real healthy sate of the skin cells. If the method of image capture and comparison is used to detect the skin, it is only able to obtain the current state of the skin, which is not in line with the concept of long term use of skin care products. The true and hidden condition of the skin cannot be reflected, if the choice of skin care products is made simply based on personal subjective description or the current state of the skin.

With the skin related gene detection and integrated analysis, the present invention is capable of obtaining inherent personal skin information, so that manufacturers can make suitable personal skin care products according to various inherent skin natures, so as to provide reliable and effective exclusive personal skin care product which is capable of improving skin health and delaying skin aging.

### SUMMARY

The present invention is aimed at providing a personal skin care product ingredient analysis device based on inherent skin information, which is capable of inputting personal data and skin related gene detection data, and automatically connected to a plurality of databases to perform interactive analysis, and finally personal skin care ingredient formula can be produced automatically, so that manufacturers can make suitable personal skin care products according to various inherent skin natures, so as to provide reliable and effective exclusive personal skin care product which is capable of improving skin health and delaying skin aging.

Therefore, a personal skin care product ingredient analysis device based on inherent skin information, in accordance with the present invention comprises: a user interface; a skin type database; a skin care product ingredient database; an analysis server; an analysis result database; a production control server; and a management control interface. Wherein the user interface is connected to the analysis server in a wire or wireless manner, the analysis server is also connected to the skin type database, a skin care product ingredient database, and the analysis result database, personal data is inputted by the user interface to the analysis server, and is calculated in the skin type database to obtain personal skin information. The personal skin information and basic information are then sent by the analysis server to the skin care product ingredient database to carry out data analysis operation, so as to obtain a personal skin care ingredient formula. The analysis server then stores the personal skin care ingredient formula and the personal skin information in the analysis result database, history analysis data is accessible via the user interface and used as basis for providing the user advice on the skin care products for internal and external use. The management control interface is connected to the production control server in a wire or wireless manner, the production control server is connected to the analysis result database and carries out data access to integrate manufacturer's procedures for manufacturing the skin care products.

User can input personal data and skin-related gene detection data to the analysis server and the skin nature classification database to perform data comparison and exchange, so as to obtain personal skin information. The analysis server will pick up the personal skin information and basic information and send them to the skin care product ingredient database to carry out data analysis operation, so as to obtain a personal skin care ingredient formula. The analysis server will send the personal skin care ingredient formula and the personal skin information to the analysis result database, the history analysis data can be quickly accessed via the user interface and used as basis for providing the user advice on the skin care products for internal and external use. The analysis result database is also connected to the production control server. The management control interface enables manufacturers to use the production control server to access the personal skin care ingredient formula stored in the analysis result database, so that manufacturers can make suitable personal skin care products based on the data in the analysis result database to provide reliable and effective exclusive personal skin care product which is capable of improving skin health and delaying skin aging.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a block diagram showing the personal skin care product ingredient analysis device based on skin information in accordance with the preferred embodiment of the present invention;

FIG. 2 is an illustrative view of the preferred embodiment of the present invention;

FIG. 3 is an illustrative view showing the inherent skin information in accordance with the preferred embodiment of the present invention;

FIG. 4 is an operational view showing the personal skin care product ingredient analysis device based on skin information in accordance with the preferred embodiment of the present invention;

FIG. 5 is another operational view showing the personal skin care product ingredient analysis device based on skin information in accordance with the preferred embodiment of the present invention; and

FIG. 6 is a block diagram showing the integrated platform for analyzing ingredients of skin care products for internal and external use in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

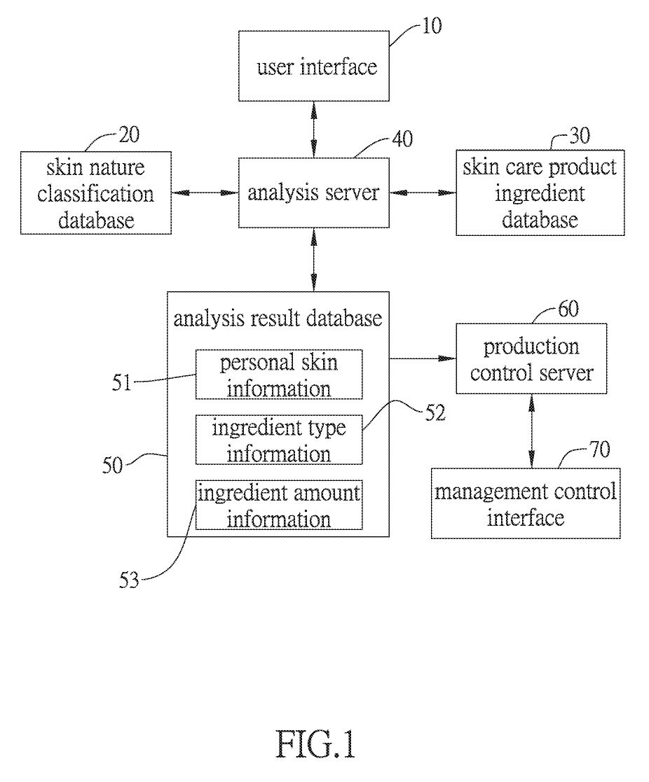

Referring to FIG. 1, a personal skin care product ingredient analysis device based on skin information in accordance with the preferred embodiment of the present invention, comprises: a user interface 10, a skin nature classification database 20, a skin care product ingredient database 30, an analysis server 40, an analysis result database 50, a production control server 60 and a management control interface 70.

The user interface 10 is connected to the analysis server 40 in a wire or wireless manner. The analysis server 40 is also connected to the skin nature classification database 20, the skin care product ingredient database 30, and the analysis result database 50, and serves as data transmission and calculation center to perform data integration and analysis. The management control interface 70 is connected to the production control server 60 in a wire or wireless manner. The production control server 60 is connected to the analysis result database 50 and carries out data access to integrate the manufacturer's procedures for manufacturing the skin care products.

The user interface 10 allows a user to input one piece or several pieces of personal data and gene detection data to the analysis server 40, and then the analysis server 40 will transmit the data to the skin nature classification database 20 to perform data comparison and exchange, so as to obtain personal skin information.

The analysis server 40 will pick up the personal skin information and basic information and send them to the skin care product ingredient database 30 to carry out data analysis operation, so as to obtain a personal skin care ingredient formula.

The analysis server 40 then integrates the personal skin care ingredient formula with the personal skin information and basic information, and formats and stores the data in the analysis result database 50. The data includes personal skin information 51, ingredient type information 52, and ingredient amount information 53, and all the information can be traced and accessed via the user interface 10.

The management control interface 70 allows manufacturers to manage and control the production control server 60, and carry out precise production. The production control server 60 can access the analysis result database 50, so that manufacturers can make suitable personal skin care products based on the data in the analysis result database 50, to provide reliable and effective exclusive personal skin care product which is capable of improving skin health and delaying skin aging.

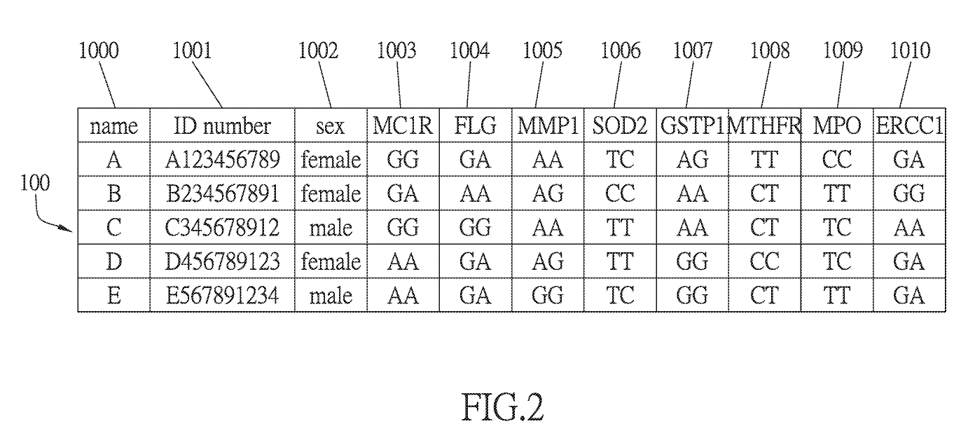

For a better understanding of the application of the present invention, reference is made to the following description when taken in conjunction with FIG. 2. The user can use the user interface 10 to input a plurality of pieces of personal data and gene detection data 100 in the form of tables to the analysis server 40, wherein the personal data and gene detection data 100 include full name 1000, identity card number (or other code number) 1001, sex 1002, melanocortin 1 receptor 1003 (MC1R), the detection results for filaggrin 1004 (FLG), interstitial collagenases 1 1005 (MMP1), superoxide dismutase 1006 (SOD2), glutathione S-transferase P1 1007 (GSTP1), methylenetetrahydrofolate reductase 1008 (MTHFR), Myeloperoxidase 1009 (MPO), and excision repair cross-complementation 1 1010 (ERCC1). The analysis server 40 transforms the information in the table into an array of data to be used for data integration analysis.

The abovementioned melanocortin 1 receptor 1003 (MC1R) is the key gene to determine the skin melanin production, its ability affects the melanin production rate. In addition to the influence on the skin color, melanin also affects the ability of the skin against ultraviolet radiation. The strong the abovementioned melanocortin 1 receptor 1003 (MC1R) is, the fast the production of melanin will be, and the skin is not easy to keep fair. However, the melanin can absorb ultraviolet, so the skin's ability to resist ultraviolet radiation is also high.

The filaggrin 1004 (FLG) has influence on the production of skin moisturizing factors. The health of the skin and the skin moisture are closely related to each other. Only maintaining the moisture of the skin can keep the skin in good condition, keeping the skin elastic and bright. When the external environment conditions are not good, the skin moisture is insufficient, the body's natural moisturizing mechanism will start to work, using the filaggrin 1004 (FLG) to increase the skin moisturizing factors, so as to maintain the moisture of the skin. The outer layer of the skin has a natural protective barrier which prevents pollutants from getting into the deep skin, and makes it difficult for the bacteria to survive in the skin surface, so that the skin can be maintained in a healthy state. The filaggrin 1004 (FLG) is also an important gene to construct the natural protective barrier, and can perfect and improve the skin natural protection mechanism, so that the skin will not be overly sensitive and won't feel uncomfortable in the face of external environmental stimuli.

The interstitial collagenases 1 1005 (MMP1) is an important regulatory gene affecting the content of collagen in the skin. With sun exposure, the role of this gene will lead to reduction of the collagen protein in the skin, making the skin lose its elasticity, and aging. Collagen is an important component in the body, can keep the skin elastic, reduce wrinkles, and maintain the youth of the skin. Therefore, the ability of this gene is closely related to whether the skin is easy to produce wrinkles.

The superoxide dismutase 1006 (SOD2) is an important gene in the body to scavenge free radicals. With the time passing, the skin condition will be affected by the free radicals accumulated in the body, and free radicals can damage skin cells, leading to skin aging. This gene can reduce the damage caused by free radicals to the skin cells, thereby slowing the skin's aging, and keeping the skin youthful and shiny.

The glutathione S-transferase P1 1007 (GSTP1) is a key gene for body detoxification and purification. Disorder of this gene will lead to cell proliferation and pressure, resulting in rough skin, wrinkles and spots, etc., which may even lead to the occurrence of skin disease. The more complete the gene function, the better the detoxification function of the cells of the skin, which consequently can keep the skin supple, compact, and the skin looks clean and clear even without wearing makeup.

The methylenetetrahydrofolate reductase 1008 (MTHFR) is a key gene to maintain the normal operation of folic acid metabolism pathway, which is involved in the nutrition absorption of skin cells, and is closely related to the function of the skin. Skin darkening and aging are all due to the abnormal metabolism of folic acid. The more complete the function of this gene, the more sufficient raw material required by skin reproduction will be produced. Once the skin is damaged, new skin will grow, which not only delays the aging of the skin, but also promote the health of the skin.

Destructive substances, such as free radicals, are often produced when skin cells are under pressure. In addition to cell damage, if the clearance mechanism disorders, the cells will be subjected to a second damage. Myeloperoxidase 1009 (MPO) is like scavengers, sleeplessly and endlessly cleaning the destructive substances. The stronger he function of this gene, the better the skin cell repair, the shorter the destructive substances stays, thus keeping skin from inflammation, and maintaining the skin healthy and shiny.

The function of the excision repair cross-complementation 1 1010 (ERCC1) is closely related to DNA repair mechanisms. When DNA is damaged because of the destructive substances, we need repair mechanisms to maintain DNA integrity and correctness, so that the gene of DNA can work properly. Ultraviolet radiation, life stress, smoking and drinking alcohol and other bad habits will cause DNA damage and cells lesion of skin. Disorder of this gene may cause skin irritation, which may lead to significant xeroderma pigmentosum. The stronger the gene function, the less likely the DNA of the cell is to be damaged, and skin cells will also be healthier.

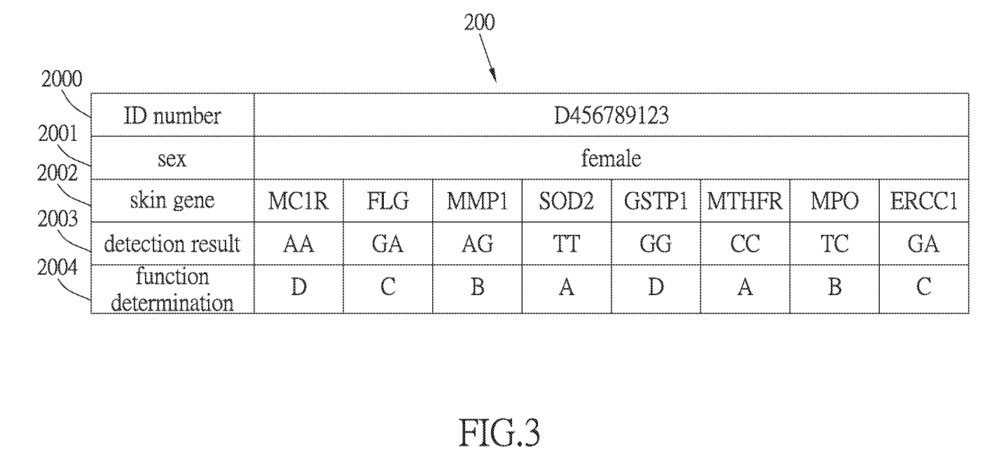

The analysis server 40 will transmit the personal data and gene detection data 100 to the skin nature classification database 20 to perform data comparison and exchange, so as to obtain personal skin information 200, as shown in FIG. 3. The personal skin information 200 includes ID number 2000, sex 2001, detection result 2003 and function determination 2004 for eight skin gene 2002 (MC1R gene, FLG gene, MMP1 gene, SOD2 gene, GSTP1 gene, MTHFR gene, MPO gene, ERCC1 gene). The function determination 2004 is obtained by weight analysis of the sex and genetic detection data. The gene function is classified into A, B, C and D classes according to the influence of the sex and genetic detection data on the gene function. Class A means that the function is normal, the function of class B is second to class A, the function of class C is second to class B, and the function of class D is the worst. The sex 2001 and the function determination 2004 of the MC1R gene, FLG gene, MMP1 gene, SOD2 gene, GSTP1 gene, MTHFR gene, MPO gene, ERCC1 gene provide important information on the personal skin. The personal skin information 200 will be used as reference data for personal skin care ingredient formula.

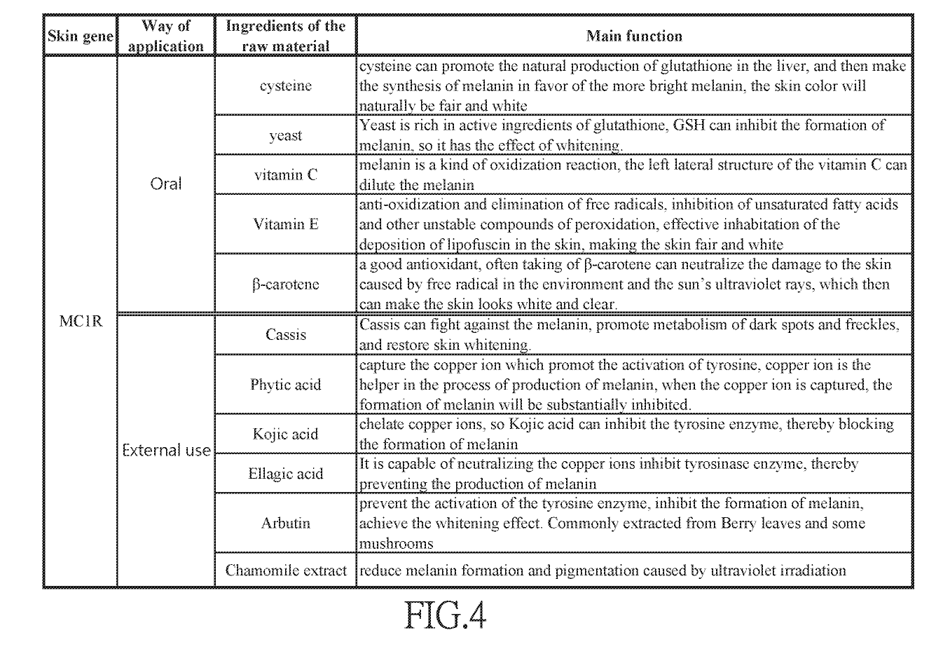

In this embodiment, the skin care product ingredient database 30 which is connected to the analysis server 40 includes information 300 on the ingredients of the raw material of different skin care products for internal and external use, as shown in FIG. 4. The raw material ingredients 3002 of the skin care product ingredient database 30 are analyzed, if the main function 3003 of each raw material ingredient is found to be able to compensate the malfunction caused by function decrease of the skin gene 3000. The skin care products can be classified into internal and external uses according to the ways of raw material application 3001, so as to promote skin health by internal and external regulation. Besides the raw material ingredients 3002, the skin care product ingredient database 30 further includes the utility information, effective dose and safe dose of the raw material, which are used as reference for reliable and effective formula of the personal skin care products.

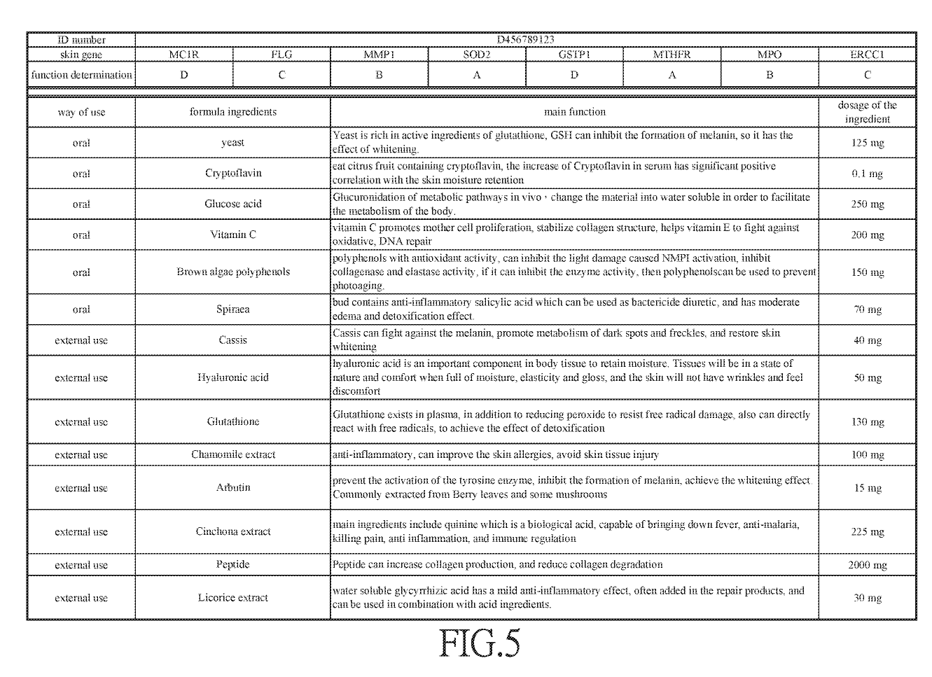

The analysis server 40 will pick up the personal skin information and transmit it to the skin care product ingredient database 30 to perform data integration and analysis, so as to obtain a personal skin care ingredient formula 400 for internal and external use, as shown in FIG. 5. The analysis server 40 will send the full personal skin information, including the ID number 4000, the skin gene 4001 and the data of the function determination 4002, to the skin care product ingredient database 30 to perform data integration and analysis, so as to obtain a corresponding formula ingredients 4004, the main function 4005, the ingredient dose 4006, and the way 4003 of use of different personal formula ingredients. The formula ingredients 4004 have been proved by research and evaluation to be able to reliably and effectively improve the personal's skin health. The way of use 4003 and the ingredient dose 4006 are obtained by comprehensive evaluation of personal skin formation, so as to produce an accurate, safe and effective formula dose for personal skin care products.

The abovementioned personal skin care ingredient formula 400 for internal and external use will be sent to the analysis server 40 and combined with the personal skin information and basic personal information, then subjected to data reorganization and formatting, and finally transmitted to and stored in the analysis result database 50.

The analysis result database 50 includes personal skin information 51, ingredient type information 52, and ingredient amount information 53. The personal skin information 51 includes full name 1000, ID number 2000, the function determination 2004 (represents personal skin type) of the skin gene 2002. The ingredient amount information 53 includes the information on ingredient dose 4006, safe dose, and dose distribution. All the information in the analysis result database 50 can be traced and accessed via the user interface 10, so as to give users appropriate advice on the skin care products for internal and external use, and provide reliable and effective exclusive personal skin care product which is capable of improving skin health and delaying skin aging.

The analysis result database 50 is further connected to the production control server 60 in addition to the analysis server 40. The production control server 60 is controlled and managed by the management control interface 70. The management control interface 70 provides a data management and production control interface, which enables the manufacturers to operate the production control server 60. The production control server 60 can access the analysis result database 50, so that manufacturers can make suitable personal skin care products based on the data in the analysis result database 50, to provide reliable and effective exclusive personal skin care product which is capable of improving skin health and delaying skin aging.

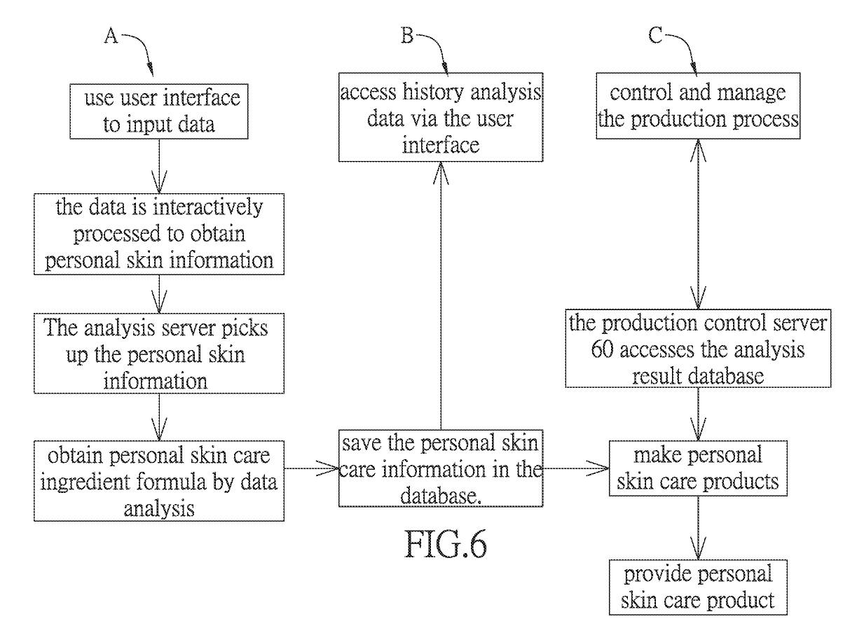

In summary, the present invention provides an integrated platform for analyzing ingredients of skin care products for internal and external use, as shown in FIG. 6.

a. after being inputted via the user interface 10, the data will be interactively processed by the analysis server 40 and the skin nature classification database 20, to obtain personal skin information. The analysis server 40 will pick up the personal skin information and basic information and send them to the skin care product ingredient database 30 to carry out data analysis operation, so as to obtain a personal skin care ingredient formula.

b. the analysis server 40 will send the personal skin care ingredient formula and the personal skin information to the analysis result database 50, the history analysis data can be quickly accessed via the user interface 10 and used as basis for providing the user advice on the skin care products for internal and external use.

c. The analysis result database 50 is also connected to the production control server 60. The management control interface 70 enables manufacturers to use the production control server 60 to access the personal skin care ingredient formula stored in the analysis result database 50, so that manufacturers can make suitable personal skin care products based on the data in the analysis result database 50, to provide reliable and effective exclusive personal skin care product which is capable of improving skin health and delaying skin aging.

The integrated platform of the present invention for analyzing ingredients of skin care products for internal and external use is an integrated evaluation method based on personal data and gene detection data, which is capable of providing suitable skin care formula based on different skin information. With this integrated platform, manufacturers can make suitable personal skin care products based on the data in the analysis result database 50, to provide reliable and effective exclusive personal skin care product which is capable of improving skin health and delaying skin aging.

While we have shown and described various embodiments in accordance with the present invention, it is clear to those skilled in the art that further embodiments may be made without departing from the scope of the present invention.

What is claimed is:

1. A personal skin care product ingredient analysis device based on inherent skin information, comprising:
a user interface;
a skin type database;
a skin care product ingredient database;
an analysis server;
an analysis result database;
a production control server; and
a management control interface;
wherein the user interface is connected to the analysis server in a wire or wireless manner, the analysis server is also connected to the skin type database, a skin care product ingredient database, and the analysis result database, personal data is inputted by the user interface to the analysis server, and is calculated in the skin type database to obtain personal skin information;
the personal skin information and basic information are then sent by the analysis server to the skin care product ingredient database to carry out data analysis operation, so as to obtain a personal skin care ingredient formula;
the analysis server then stores the personal skin care ingredient formula and the personal skin information in the analysis result database, history analysis data is accessible via the user interface and used as basis for providing the user advice on the skin care products for internal and external use;
the management control interface is connected to the production control server in a wire or wireless manner, the production control server is connected to the analysis result database and carries out data access to integrate manufacturer's procedures for manufacturing the skin care products.

2. The personal skin care product ingredient analysis device based on inherent skin information as claimed in claim 1, wherein the user interface inputs personal data and gene detection data in the form of tables to the analysis server.

3. The personal skin care product ingredient analysis device based on inherent skin information as claimed in claim 2, wherein the gene detection data include melanocortin receptor, detection results for filaggrin, interstitial collagenases, superoxide dismutase, glutathione S-transferase P, methylenetetrahydrofolate reductase, Myeloperoxidase, and excision repair cross-complementation.

4. The personal skin care product ingredient analysis device based on inherent skin information as claimed in claim 1, wherein the personal skin information include identification card number, sex, detection results and function determination for filaggrin, interstitial collagenases, superoxide dismutase, glutathione S-transferase P, methylenetetrahydrofolate reductase, Myeloperoxidase, and excision repair cross-complementation.

5. The personal skin care product ingredient analysis device based on inherent skin information as claimed in claim 1, wherein analysis result database includes personal skin information, ingredient type information, and ingredient amount information.

6. The personal skin care product ingredient analysis device based on inherent skin information as claimed in claim 1, wherein all the information stored in the analysis result database can be traced and accessed via the user interface.

7. The personal skin care product ingredient analysis device based on inherent skin information as claimed in claim 1, wherein the analysis result database is further connected to the production control server, the management control interface enables manufacturers to use the production control server to access the personal skin care ingredient formula stored in the analysis result database, and allows manufacturers to make suitable personal skin care products.
